(19) United States
(12) Patent Application Publication
(10) Pub. No.: US 2021/0317011 A1
(43) Pub. Date: Oct. 14, 2021

(54) TREATMENT REACTOR AND METHOD OF TREATING A LIQUID

(71) Applicant: LIVERPOOL JOHN MOORES UNIVERSITY, Liverpool (GB)

(72) Inventors: Khalid HASHIM, Liverpool (GB); Andrew SHAW, Liverpool (GB); David PHIPPS, Liverpool (GB)

(21) Appl. No.: 17/268,077

(22) PCT Filed: Sep. 6, 2019
(86) PCT No.: PCT/GB2019/052493

§ 371 Date: Feb. 11, 2021

(30) Foreign Application Priority Data
Sep. 7, 2018 (GB) 1814584.7

(51) Int. Cl. C02F 1/463; C02F 1/30

(52) U.S. Cl. CPC C02F 1/463; C02F 2001/46133; C02F 1/302

(57) ABSTRACT

Disclosed is a treatment reactor for treating a continuously flowing liquid, comprising: an inlet for receiving liquid to be treated; and an outlet for outputting the treated liquid, whereby the liquid flows from the inlet to the outlet, wherein the reactor comprises an electrolysis unit arranged to subject the flowing liquid to electrolysis, and a microwave unit arranged to subject the flowing liquid to a microwave field.

### BACKGROUND OF THE INVENTION

The present invention relates to treatment reactors and methods of treating a liquid, and more particularly, a treatment reactor that utilises a combination of microwave-electrocoagulation that can be applied to treat liquid containing organic matter-heavy metals complexes.

Apparatuses and methods for treating, sterilising and pasteurising using microwave radiation are known. Although microwave radiation alone can be used to destroy pathogens and decompose organic matter, it is not able to remove other types of pollutants such heavy metals.

Electrocoagulation (EC) is an effective water and wastewater treatment technology, wherein the coagulants are generated in-situ by electrolytic oxidation of a sacrificial anode. In this technique, pollutant removal is done without adding chemicals. As a result, it significantly reduces the sludge produced, and consequently reduces the cost of sludge handling. However, the performance of EC technology is heavily influenced by the presence of organic matter (OM), as this inhibits heavy metal removal due to the formation of OM-heavy metal complexes.

Accordingly, improved liquid treatment reactors and methods are needed. Ideally, a liquid treatment reactor should be capable of reliably removing OM-heavy metal complexes, while producing minimal resulting end-products.

Example embodiments aim to address problems associated with existing related solutions, whether specifically mentioned above or which can otherwise be appreciated from the discussion herein.

### SUMMARY OF THE INVENTION

In one aspect there is provided a treatment reactor for treating a continuously flowing liquid, comprising an inlet for receiving liquid to be treated, and an outlet for outputting the treated liquid, whereby the liquid flows from the inlet to the outlet, wherein the reactor comprises an electrolysis unit arranged to subject the flowing liquid to electrolysis, and a microwave unit arranged to subject the flowing liquid to a microwave field.

In one example, the treatment reactor further comprises a heat exchanger for controlling the reaction temperature. In one example, the heat exchanger comprises a plurality of tubes made from a conducting metal were added after the microwave unit.

In one example, the electrolysis unit comprises a plurality of electrodes. In one example, the electrodes comprise aluminium. In one example, at least one of the electrodes comprises a plurality of perforations, whereby the liquid flows through the plurality of perforations. In one example, the electrodes are arranged in a configuration which causes the liquid to follow a convoluted path. In one particular example, the electrodes are arranged vertically inside the reactor, with each electrode rotated horizontally by an angle of 22.5° from the one above it.

In one example, the microwave unit has an output that has a frequency in the range from 896 MHz to 2.45 GHz. In one particular example, the microwave unit has an output that has a frequency of 2.45 GHz.

In one example, the microwave unit is configured to operate at a power in the range from 50 W to 36 kW. In one particular example, the microwave unit is configured to operate at a power of 100 W.

In one example, the treatment reactor is coupleable with a remote power supply. In one example, the remote power supply is a battery. In one example, the remote power supply is a photovoltaic cell.

In one example, the microwave unit is separated from the electrolysis unit.

In another aspect there is provided a method of treating a continuously flowing liquid, the method comprising the steps of inputting the liquid to be treated, causing the liquid to flow through a first electrolysis unit to electrolyse the liquid, and a first microwave unit to subject the liquid to a microwave field, and outputting the treated liquid.

In one example, the liquid is caused to flow through the first electrolysis unit, the first microwave unit, and a second electrolysis unit, respectively.

In one example, the liquid is subjected to a microwave field for 5 to 15 minutes. In one particular example, the liquid is subjected to a microwave field for 10 minutes.

In one example, the method further comprises cooling the liquid after subjecting it to the microwave field. In one particular example, the method further comprises cooling the liquid to a temperature in the range of 19 to 21° C. using a heat exchanger.

In one example, the liquid is electrolysed at a current density in the range from 1 to 2 mA/cm². In one particular example, the liquid is electrolysed at a current density of 1.5 mA/cm².

In one example, the method further comprises removing a sludge.

### BRIEF DESCRIPTION OF THE DRAWINGS

For a better understanding of the invention, and to show how embodiments of the same may be carried into effect, reference will now be made, by way of example only, to the accompanying diagrammatic drawings in which:

FIG. 1 illustrates a treatment reactor in accordance with a first embodiment of the present invention.

FIG. 2 illustrates a treatment reactor in accordance with a second embodiment of the present invention.

FIG. 3 illustrates a treatment reactor in accordance with a third embodiment of the present invention.

FIG. 4A illustrates a top view and a side view of an electrolysis unit in accordance with an embodiment of the present invention.

FIG. 4B illustrates a pair of electrodes to be used within the electrolysis unit in accordance with an embodiment of the present invention.

FIG. 5 illustrates an exemplary method for treating a liquid using a treatment reactor.

### DETAILED DESCRIPTION OF THE EXAMPLE EMBODIMENTS

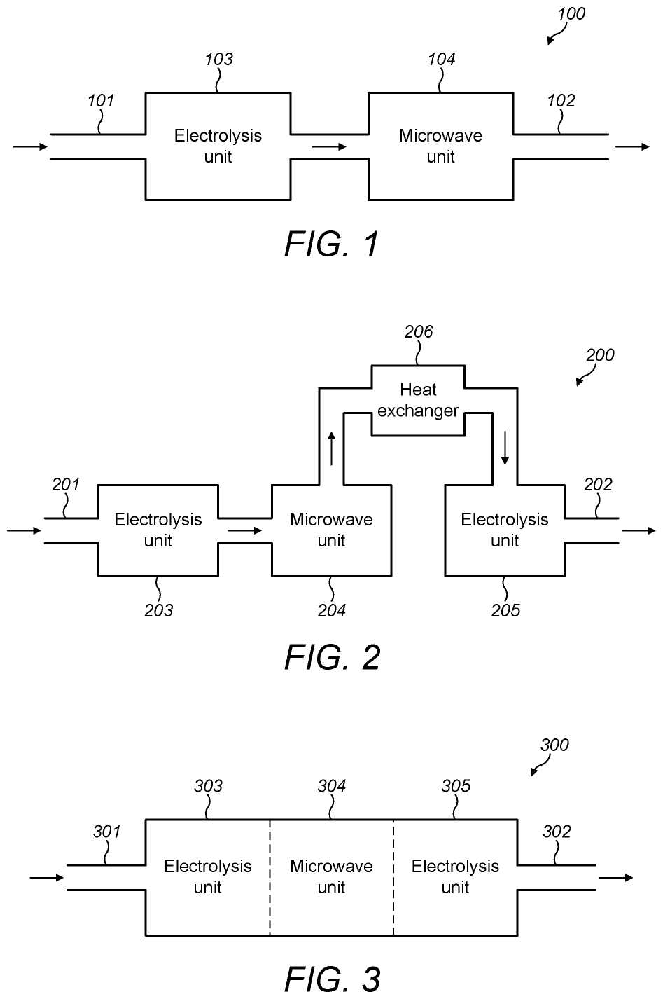

FIG. 1 illustrates a treatment reactor 100 in accordance with a first embodiment of the present invention. The treatment reactor 100 comprises an inlet 101 for receiving liquid to be treated, and an outlet 102 for outputting the treated liquid, whereby the liquid flows from the inlet 101 to the outlet 102. The treatment reactor 100 further comprises an electrolysis unit 103 arranged to subject the flowing liquid to electrolysis, and a microwave unit 104 arranged to subject the flowing liquid to a microwave field. In a preferred embodiment, the electrolysis unit 103 is isolated from the microwave unit 104.

As such, the electrolysis and the microwaving processes may be carried out in continuous mode, rather than being performed intermittently. The continuous mode of operation improves the industrial applicability of the treatment reactor 100, making the reactor more suitable for use in wastewater treatment.

In addition, as the electrocoagulation and the microwaving processes are carried out in separate chambers, the efficiency of the treatment reactor 100 may be increased. Metallic electrodes used in electrolysis units may reflect some of the microwave radiation, effectively reducing the amount of the microwave radiation absorbed by the flowing liquid.

The microwave unit 104 has an output that has a frequency in the range from 896 MHz to 2.45 GHz. In a preferred embodiment, the microwave unit 104 has an output that has a frequency of 2.45 GHz. As such, the size of the microwave unit 104 may be reduced. Additionally, 2.45 GHz sources are cheaper than other sources.

The microwave unit 104 is configured to operate at a power in the range from 50 W to 36 kW. While increasing the power of the microwave unit 104 improves the ability to remove heavy metals from the liquid, it has the drawback of increasing power consumption. In a preferred embodiment, the microwave unit is configured to operate at a power of 100 W.

The liquid flowing through the microwave unit 104 is subjected to a microwave field for 5 to 15 minutes. In a preferred embodiment, the liquid is subjected to a microwave unit for 10 minutes. In continuous flow, this is the mean residence time, i.e. the average time any element of fluid stays in the reactor.

FIG. 2 illustrates a treatment reactor 200 in accordance with a second embodiment of the present invention. In the embodiment of FIG. 2, the treatment reactor 200 comprises a first electrolysis unit 203 and a second electrolysis unit, such that a liquid to be treated flows from an inlet 201, through a first electrolysis unit 203, to a microwave unit 204; and from the microwave unit 204, to heat exchanger, to a second electrolysis unit 205, to be output by an outlet 202. The use of the second electrolysis unit increases the ability to remove of complex pollutants from the liquid being treated.

The treatment reactor according to the exemplary embodiments comprises a heat exchanger for controlling the reaction temperature. In particular, the heat exchanger may be used to dissipate the extra temperature generated as a result of removal of hot industrial effluents from the liquid. In a preferred embodiment, the heat exchanger is realised by embedding a number of tubes, made from a conducting material, inside the electrolysis unit.

FIG. 3 illustrates a treatment reactor 300 in accordance with a third embodiment of the present invention. In the embodiment of FIG. 3, the treatment reactor 300 comprises a first electrolysis unit 303 and a second electrolysis unit 305, such that a liquid to be treated flows from an inlet 301, through a first electrolysis unit 303, to a microwave unit 304; and from the microwave unit 304, to a second electrolysis unit 305, to be output by an outlet 302. However, compared to the embodiment of FIG. 2, the units are not physically isolated from each other.

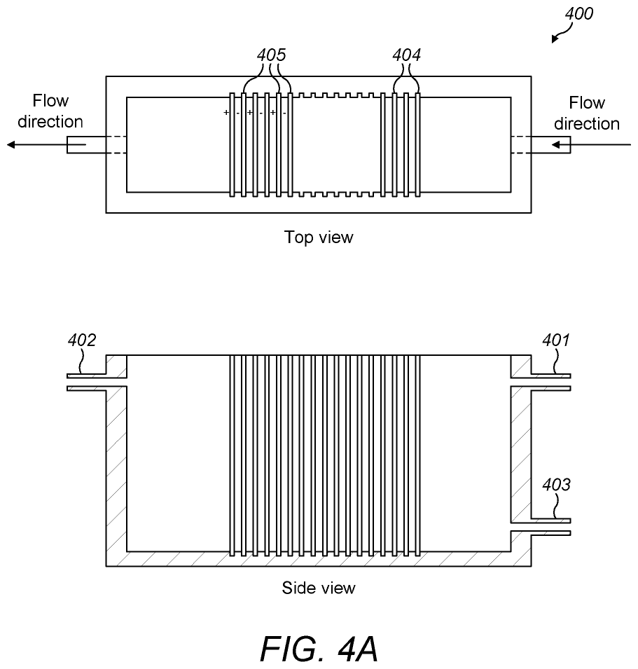

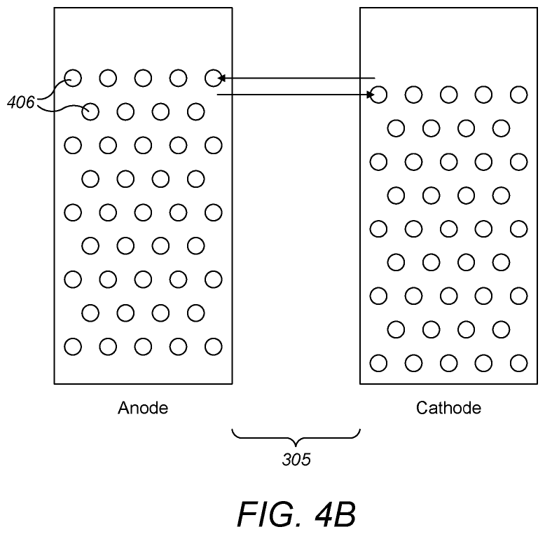

FIG. 4A illustrates a top view and a side view of an electrolysis unit in accordance with either the first or the second embodiment of the present invention. The electrolysis unit 400 comprises an upper inlet 401 for direct flow of a liquid to be treated, a lower inlet 403 for back flow of the liquid, a plurality of mixing plates 404, a plurality of electrodes 405, and an outlet 402 for outputting the electrolysed liquid. The lower inlet 403 may actuate a fluidised bed system, further improving the mixing process. In one example, the fluidised bed system decreased the mixing time by 11%.

FIG. 4B illustrates a pair of electrodes to be used within the electrolysis unit in accordance with an embodiment of the present invention. In a preferred embodiment, the electrodes 405 comprise aluminium.

The electrolysis process itself is achieved via the use of a plurality of perforated electrodes 405. The location of the corresponding perforations 406 differs between the anodes and the cathodes; for example, the perforations located in the cathodes may be shifted vertically by a distance of 1 cm with respect to the perforations of the anodes. In a preferred embodiment of the invention, the electrodes 405 are arranged vertically inside the treatment reactor, with each electrode rotated horizontally by an angle of 22.5° from the one above it. However, it will be appreciated by those skilled in the art that other arrangements of the electrodes may be used in other embodiments to achieve similar results.

The perforated electrodes 405 cause the flowing liquid follows a convoluted path, enabling mixing and oxygenation of the liquid without the use of dedicated mixing and aeration equipment. As fewer units are required for the electrolysis unit to operate, the power consumption of the treatment reactor may decrease.

As liquid treatment may need to be performed in locations where the access to a power supply is limited, it is desirable to minimise the power consumption of a treatment reactor. The treatment reactor according to an exemplary embodiment operates using a power supplied to it from a remote power supply such as a battery. As such, the treatment reactor may be less cumbersome and therefore easier to deploy in remote locations where liquid treatment is desired.

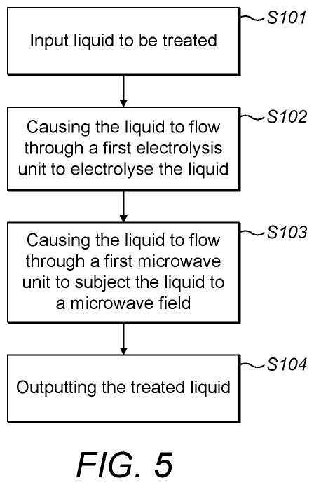

FIG. 5 shows a schematic flow diagram of a method for treating a liquid using a treatment reactor according to an example embodiment. At step S101 the method comprises inputting a liquid to be treated. At step S102 the method comprises causing the liquid to flow through a first electrolysis unit to electrolyse the liquid. At step S103 the method comprises causing the liquid to flow through a first microwave unit to subject the liquid to a microwave field. At step S104 the method comprises outputting the treated liquid.

Subjecting the flowing liquid to a microwave field will result in an increase in temperature of the liquid. As such, in a preferred embodiment, the method comprises cooling the liquid after subjecting it to the microwave field. Preferably, the liquid is cooled to a temperature in the range of 19 to 21° C., which is very suitable for EC unit.

As will be appreciated, the steps S102 and S103 may be performed or repeated in either order, enabling an efficient way of treating liquid.

As a consequence of pollutant removal from a liquid, a sludge may be generated. The sludge may deposit at the bottom of the treatment reactor. In order to maintain the treatment reactor in an operable state, the sludge is cyclically removed. In a preferred embodiment, a blade-like structure is inserted into the treatment reactor to facilitate the removal of the sludge.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A treatment reactor for treating a continuously flowing liquid, comprising:
an inlet for receiving liquid to be treated; and
an outlet for outputting the treated liquid, whereby the liquid flows from the inlet to the outlet,
wherein the reactor comprises an electrolysis unit arranged to subject the flowing liquid to electrolysis, and a microwave unit arranged to subject the flowing liquid to a microwave field.

2. The treatment reactor of claim 1, further comprising a heat exchanger for controlling the reaction temperature.

3. The treatment reactor of claim 2, wherein the heat exchanger comprises a plurality of tubes made from a conducting material.

4. The treatment reactor of claim 1, wherein the electrolysis unit comprises a plurality of electrodes.

5. The treatment reactor of claim 4, wherein the electrodes comprise aluminium.

6. The treatment reactor of claim 4, wherein at least one of the electrodes comprises a plurality of perforations, whereby the liquid flows through the plurality of perforations.

7. The treatment reactor of claim 4, wherein the electrodes are arranged in a configuration which causes the liquid to follow a convoluted path.

8. The treatment reactor of claim 1, wherein the microwave unit has an output that has a frequency in the range from 896 MHz to 2.45 GHz.

9. The treatment reactor of claim 1, wherein the microwave unit is arranged to operate at a power in the range from 50 W to 36 kW.

10. The treatment reactor of claim 1, wherein the treatment reactor is coupleable with a remote power supply.

11. The treatment reactor of claim 10, wherein the remote power supply comprises a battery.

12. The treatment reactor of claim 10, wherein the remote power supply comprises a photovoltaic cell.

13. The treatment reactor of claim 1, wherein the electrolysis unit is isolated from the microwave unit.

14. A method of treating a continuously flowing liquid, the method comprising the steps of:
inputting the liquid to be treated;
causing the liquid to flow through a first electrolysis unit to electrolyse the liquid and
a first microwave unit to subject the liquid to a microwave field; and outputting the treated liquid.

15. The method of claim 14, wherein the liquid is caused to flow through:
the first electrolysis unit, the microwave unit, and a second electrolysis unit, respectively.

16. The method of claim 14, wherein the liquid is subjected to a microwave field for 5 to 15 minutes.

17. The method of claim 14, further comprising the step of cooling the liquid after subjecting it to the microwave field.

18. The method of claim 14, wherein the liquid is electrolysed at a current density in the range from 1 to 2mA/cm²

19. The method of claim 14, further comprising the step of removing a sludge.
